(19) United States
(12) Patent Application Publication
(10) Pub. No.: US 2004/0049512 A1
(43) Pub. Date: Mar. 11, 2004

(54) Information processing system and information processing method

(75) Inventor: Yasuhiro Kawakita, Osaka (JP)

Correspondence Address: VENABLE, BAETJER, HOWARD AND CIVILETTI, LLP, P.O. BOX 34385, WASHINGTON, DC, 20043-9998, US

(73) Assignee: Oki Electric Industry Co., Ltd., Tokyo (JP)

(21) Appl. No.: 10/602,032

(22) Filed: Jun. 24, 2003

(30) Foreign Application Priority Data
Jun. 24, 2002 (JP) 2002-182791

(51) Int. Cl. G06F 17/00

(52) U.S. Cl. 707/100

(57) ABSTRACT

An information processing system and an information processing method capable of improving reliability and convenience and maintaining the reliability high are provided. The information processing system for processing unit data including a plurality of information elements partitioned at predetermined divisions, includes: a division processing section 102 dividing the unit data into the plurality of information elements based on the divisions; a condition determination section 103 supplied with a select condition, and selecting the information element conformable to the select condition from among the plurality of information elements obtained by dividing the unit data; and a notification section 104 notifying a user of the information element selected by the condition determination section. This system preferably includes an extraction processing section 203 allocating a logical structure to each of the information elements divided by the division processing section, the logical structure indicating a meaning of each information in each of the information elements.

### BACKGROUND OF THE INVENTION

The present invention relates to an information processing system and an information processing method which are suited in use for, for example, receiving and processing a mail magazine.

Description of the Related Art

As a conventional system for automatically collecting information that a use wants and transmitting the collected information to the user, there is known a system described in the following Document 1 (Japanese Patent Laid-Open Publication No. 11-203189).

Document 1 proposes the following mechanism. The system described in Document 1 acquires information presented by each of information sources such as Websites and broadcasting based on a predetermined schedule, creates summaries of the information, and manages the summaries as well as the locations of the information sources as HTML documents.

A keyword and the call number of a terminal used by a user are set. If the system obtains information coincident with the keyword, the system transmits a notification consisting of the information summaries and location information on the information sources to a location indicated by the call number.

If the information source itself is a Web page, it is written in the form of an HTML document. In addition, the notification is described in the form of an HTML document so as to describe a hyperlink representing the location of the information. According to Document 1, the summary is a part with an appropriate number of characters from the start of the body of the HTML document.

Therefore, to create such a summary, the body of the HTML document is fetched and a part with an appropriate number of characters from the start thereof is extracted.

Meanwhile, the system described in Document 1 effectively operates if it obtains an HTML document described in respect of one case. If the system obtains a document, such as a news mail magazine, consisting of a plurality of articles, the system may notify the summary of the first article but may not notify those of the second and the following articles. This means that if a keyword conforms to the second and the following articles, a contradiction that the first summary is transmitted occurs, which deteriorates the reliability of the system.

In this case, the user is notified of an unexpected summary of irrelevance to the keyword set by the user oneself. As a result, the user is incapable of understanding the meaning of the notification and may possibly feel uncertain about the normality of the system, thus again deteriorating the reliability of the system.

Further, if the user utilizes the location information on the information source which, as well as the summary of the information, is notified to the user and which is indicated by a hyperlink or the like, the user can view detailed information on the article conforming to the user set keyword. However, in order to operate a Web browser and access a Web page based on the location information, the user needs lots of operations. Besides, since the detailed information is often lengthy, the user needs labor and time to read such lengthy information, which deteriorates the convenience of the system.

Moreover, the summary is formed by merely clipping a part with an appropriate number of characters from the start of the HTML document (which is an article in case of a mail magazine). Due to this, even if the contradiction does not occur, it is not ensured that the summary accurately expresses the content of the article. In the end, it is highly likely that the user has to view the detailed information so as to know the content of the article.

### SUMMARY OF THE INVENTION

To solve the above-stated disadvantages, according to the first invention, there is provided an information processing system for processing unit data including a plurality of information elements partitioned at predetermined divisions, the system characterized by including: (1) a division processing section dividing the unit data into the plurality of information elements based on the divisions; (2) a condition determination section supplied with a select condition, and selecting the information element conformable to the select condition from among the plurality of information elements obtained by dividing the unit data; and (3) a notification section notifying a user of the information element selected by the condition determination section.

According to the second invention, there is provided an information processing method for processing unit data including a plurality of information elements partitioned at predetermined divisions, the method characterized by including the steps of: (1) allowing a division processing section to divide the unit data into the plurality of information elements based on the divisions; (2) allowing a condition determination section to be supplied with a select condition, and to select the information element conformable to the select condition from among the plurality of information elements obtained by dividing the unit data; and (3) allowing a notification section to notify a user of the information element selected by the condition determination section.

### BRIEF DESCRIPTION OF THE DRAWINGS

FIG. 1 is a schematic diagram showing an example of the configuration of the important sections of a mail processor in the first embodiment according to the present invention;

FIG. 2 is an example of the configuration of the body of a mail magazine used in the first and second embodiments;

FIG. 3 is a flow chart showing the operation of the first embodiment;

FIG. 4 shows an example of a display screen which represents the operation of the first embodiment;

FIGS. 5A, 5B and 5C show an example of dividing the body of the mail magazine in the first and second embodiments;

FIGS. 6A, 6B and 6C are explanatory views for the operation of the second embodiment;

FIG. 7 shows an example of the configuration of an article, to which a logical structure has been added, in the second embodiment;

FIG. 8 is a schematic diagram showing an example of the configuration of the important sections of a mail processor in the second embodiment;

FIG. 9 is a flow chart showing the operation of the second embodiment;

FIG. 10 is an example of the configuration of the body of the mail magazine in the second embodiment;

FIGS. 11A, 11B and 11C show an example of dividing the body of the mail magazine in the second embodiment;

FIG. 12 shows an example of the configuration of an article to which a logical structure has been added (if a summary exists) in the second embodiment;

FIG. 13 shows an example of the configuration of the article to which a logical structure has been added (if a no summary exists) in the second embodiment;

FIG. 14 is an operation explanatory view for an compensation processing in the second embodiment;

FIG. 15 shows an example of the configuration of the article to which the logical structure has been added (if the summary is compensated) so as to show the advantage of the compensation processing in the second embodiment; and

FIG. 16 is a schematic diagram showing an example of the overall configuration of a communication system in the first and second embodiments.

### DETAILED DESCRIPTION OF THE PREFERRED EMBODIMENTS

(A) First Embodiment

An information processing system and an information processing method according to the present invention will be described hereinafter while taking the application of the system and the method to a mail magazine processing as an example. Namely, the information processing system and the information processing method according to the present invention are intended to process unit data which contains a plurality of pieces of information. In this embodiment, a news mail magazine as the unit data will be described while exemplifying articles of the news mail magazine as a plurality of pieces of information.

A mail magazine is a magazine (or a newspaper) using e-mail, and a service for providing e-mails in which many articles belonging to diversified genres are written to many subscribers.

Therefore, unless violating this definition, the e-mail can be regarded as a mail magazine no matter how the e-mail is provided to each subscriber. For example, the publisher of mail magazine may deliver the e-mail to each of many subscribers by describing e-mail addresses of all the subscribers in the BCC field of a mail header. With this method, however, the publisher requires heavily loaded management and there is a high probability that e-mails are not sent to the original subscribers because of the mistake, lack or the like of filling in the mail addresses of the destinations. For this reason, a mailing list system is normally used for mail magazines.

The mailing list system is a kind of a broadcasting system regarded as a subsystem of an e-mail system. According to this system, if a publisher sends an e-mail (a mail magazine) to a specific e-mail address only once, mail magazines of the same contents are automatically delivered to the e-mail addresses of all subscribers. According to a mail magazine system, however, differently from an ordinary mailing list, it is permitted to send a one-sided e-mail only from a magazine publisher and prohibited to send e-mails from subscribers.

Although the mail magazine is dealt with differently from the other e-mails by the magazine publisher or the subscribers, processings performed by the constituent elements of an e-mail system such as a mail server or a mailer on the part of the publisher and the subscribers are exactly the same as those for ordinary e-mails.

(A-1) Configuration of First Embodiment

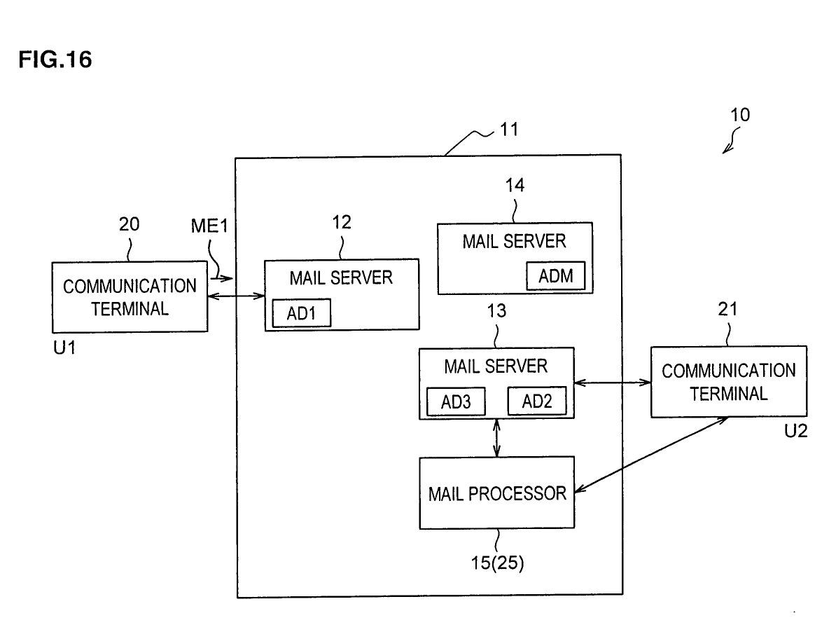

FIG. 16 shows an example of the overall configuration of a communication system 10 in the first embodiment.

In FIG. 16, the communication system 10 includes a network 11, mail servers 12 to 14, a mail processor 15, and communication terminals 20 and 21.

Among these constituent elements, the network 11 may be a LAN (local area network). In this embodiment, however, the network 11 is the Internet.

The communication terminal 20 is operated by a user U1 who is the publisher of the mail magazine and may be, for example, an ordinary personal computer having a mailer installed therein.

The communication terminal 21 is operated by a user U2 who is one of many subscribers of the mail magazine and may be, for example, an ordinary personal computer having a mailer installed therein.

The mail server 12 is an ordinary mail server. The mail server 12 has a function as an SMTP server which delivers e-mails (including a mail magazine ME) transmitted from the communication terminal 20 according to destination addresses and a function, opposite to the former function, as a POP server which receives e-mails delivered to the address of the communication terminal 20 (with an e-mail address AD1) and which enables the communication server 20 to fetch the e-mails. (As for the latter function, a protocol for fetching e-mails is not limited to POP but may be IMAP4 or the like.) The e-mail address of the user U1 is AD1 and a mail box corresponding to the e-mail address AD1 is provided in the mail server 12.

Likewise, the mail server 13 is an ordinary mail server. The mail server 14 has a function as an SMTP server which delivers e-mails transmitted from the communication terminal 21 according to destination addresses and a function, opposite to the former function, as a POP server which receives e-mails delivered to the address of the communication terminal 21 (with an e-mail address AD2) and enables the communication terminal 21 to fetch the e-mails. (As for the latter function, a protocol for fetching e-mails is not limited to POP but may be IMAP4 or the like.)

The third mail server 14 may be basically equal to the mail servers 12 and 13 except that the mail server 14 manages an e-mail address ADM for a mailing list and cooperates with the mailing list system (not shown).

The e-mail address ADM for the mailing list is stored and managed by the mailing list system while making the address ADM correspond to the e-mail addresses of many subscribers including the e-mail address AD2 of the user U2. If the e-mail (mail magazine) ME1 is transmitted to the e-mail address ADM, the mail server 14 cooperates with the mailing list system to repeat an operation for changing an e-mail address for designating a destination (content of “To field”) described in the mail header of the e-mail ME1 from ADM to AD2 or the like. The mail server 14 thereby delivers the e-mails ME1 having bodies equal in content to the stored e-mail addresses of all the subscribers, respectively.

It is thereby possible to use an e-mail which is basically a one-to-one communication means as a one-to-many communication means.

Consequently, the e-mail (mail magazine) ME1 delivered to the mail box of each subscriber is received and stored in the mail box of each subscriber (such as the mail box of the user U2 corresponding to the e-mail address AD2) similarly to e-mails (as one-to-one communication means) other than the mail magazine ME1.

While the configuration of the communication system 100 has been described while centering on the three mail servers 12 to 14, it goes without saying that arbitrary two or all of the three mail servers can be computers equal in hardware.

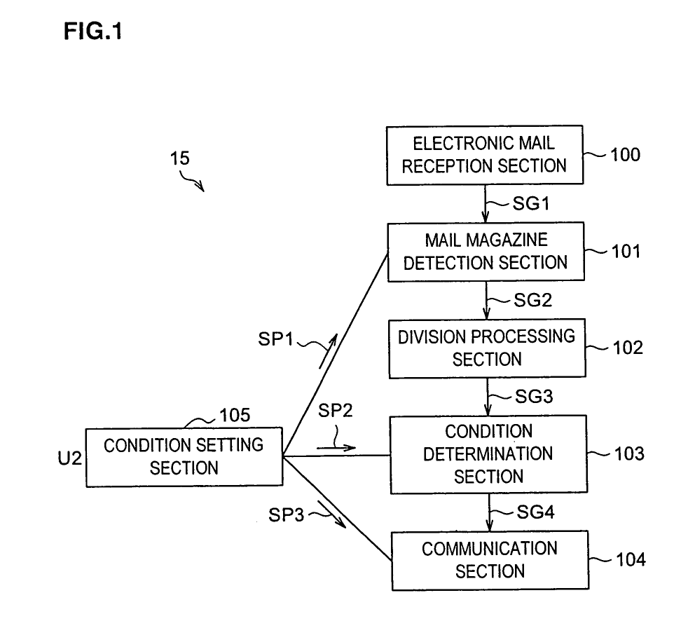

Next, a mail processor 15 serving as a characteristic constituent elements according to the present invention will be described. FIG. 1 shows an example of the configuration of the important sections of a mail processor 15.

(A-1-1) Example of the Configuration of Mail Processor

Referring next to FIG. 1, the mail processor 15 includes an e-mail reception section 100, a mail magazine detection section 101, a division processing section 102, a condition determination section 103, and a notification section 104.

Among the constituent elements 100 to 105 shown in FIG. 1, only a condition setting section 105 is the constituent element belonging not to the mail processor 15 but to the communication terminal 21. The condition setting section 105 is used when various settings are made to the mail processor 15 by the communication terminal 21.

This condition setting section 105 may be constituted out of a dedicated software or hardware. In this embodiment, the condition setting section 105 is constituted out of a Web browser installed in almost any personal computer.

In this embodiment, therefore, the constituent elements 101, 103, and 104 of the mail processor 15 relative to the condition setting section 105 function as a Web server which provides a Web page (form) for setting.

Among the constituent elements 100 to 104 of the mail processor 15, the e-mail reception section 100 can be regarded as a section corresponding to a mail box associated with the e-mail address AD2 of the user U2. In this embodiment, however, the e-mail reception section 100 is an interface between the mail box and the mail processor 15.

The mail server 13 is provided with not only the mail box for the e-mail address AD2 of the user U2 but also many other mail boxes (including a mail box for AD3). The users of the other mail boxes can subscribe to mail magazines and use the mail processor 15. Since conditions set by the condition setting sections 105 normally differ among the users, the constituent elements 101, 103, and 104 that receive the various conditions set by the condition setting section 105 from the condition setting section 105 need to execute different processings among the users.

Due to this, the e-mail reception section 100 needs to perform processings while identifying the names of the respective mail boxes in the mail server 13.

Generally, an e-mail address is in the form of “user2@server”, “user3@server” or the like. Symbols after mark @ signify a domain name (mail server name) whereas those before mark @ signify the name of the mail box of each user (user name). Thus, the constituent elements 101, 103, and 104 as well as the e-mail reception section 100 can identify each user based on the mail box name (e.g., user2).

The mail magazine detection section 101 detects a mail magazine ME1 to be processed by the mail processor 15 from e-mails stored in the mail box according to a detection condition SP1 set and received by the condition setting section 105 in advance.

As described above, not only the mail magazine ME1 but also other ordinary e-mails (e-mails as one-to-one communication means) are received in the mail box for AD2 and stored therein. Therefore, the mail magazine detection section 101 detects only the mail magazine (ME1 in this embodiment).

If the user U2 subscribes to multiple mail magazines, a processing target of the mail processor 15 can be freely set such as, for example, processing a specific mail magazine by the mail processor 15 and not processing the remaining mail magazines by the mail processor 15, by the setting of the detection condition SP1 for this mail magazine detection section 101.

It is noted, however, that if all the e-mails received in the mail box including the mail magazines are to be processed by the mail processor 15, the mail magazine detection section 101 can be omitted.

Various methods (mail magazine detection method) may be considered to allow the mail magazine detection section 101 to detect the mail magazine ME1 to be processed by the mail processor 15 from the e-mails received and stored in the mail box. For example, the mail magazine detection section 101 analyzes the contents of the bodies of the respective e-mails stored in the mail box and checks whether the e-mails are mail magazines to thereby detect the mail magazine ME1. In this embodiment, the mail magazine detection section 101 detects the mail magazine ME1 using information described in mail headers.

Among the information described in mail headers, attention is paid to, for example, the e-mail addresses of senders. As described above, the mail magazine ME1 is an e-mail by broadcasting the e-mail transmitted from the publisher with the e-mail address AD1 to the mailing list with the e-mail address ADM. Due to this, in the mail header of the mail magazine ME1, AD1 or ADM is described in a field (“From field”) for describing the e-mail address of the sender.

Whether the e-mail address AD1 of the publisher or the e-mail address ADM of the mailing list is described in the From field of the mail magazine ME1 is determined according to whether or not the mail server 14 rewrites the From field of the mail magazine ME1 transmitted from the mail server 12 (note, AD1 is normally described in the From field when the mail magazine ME1 is received by the mail server 14). In addition, if the publisher does not want to make the e-mails AD1 and ADM open to the subscribers, the third mail address other than AD1 and ADM may be described in this From field.

In any case, the user U2 can know the e-mail address AD1 or ADM (or the third e-mail address) in advance, so that the user U2 can set the e-mail address as the detection condition SP1 using the condition setting section 105.

If the mail magazine detection method using the e-mail address of the sender is used, the user U2 operates the communication terminal 21 to supply the e-mail address (e.g., AM) as the detection condition SP1 to the mail magazine detection section 101 in advance.

By thus using the mail magazine detection method using the e-mail address of the sender, it is possible to extremely facilitate and ensure detecting the mail magazine ME1. The mail magazine detection section 101 may execute this mail magazine detection method either periodically or whenever a new e-mail is received in the mail box (or the user U2 explicitly instructs the detection section 101 to execute the method).

The division processing section 102 divides the contents described in the body of the e-mail (e.g., ME1) that the mail magazine detection section 101 determines to be a mail magazine into segments according to articles.

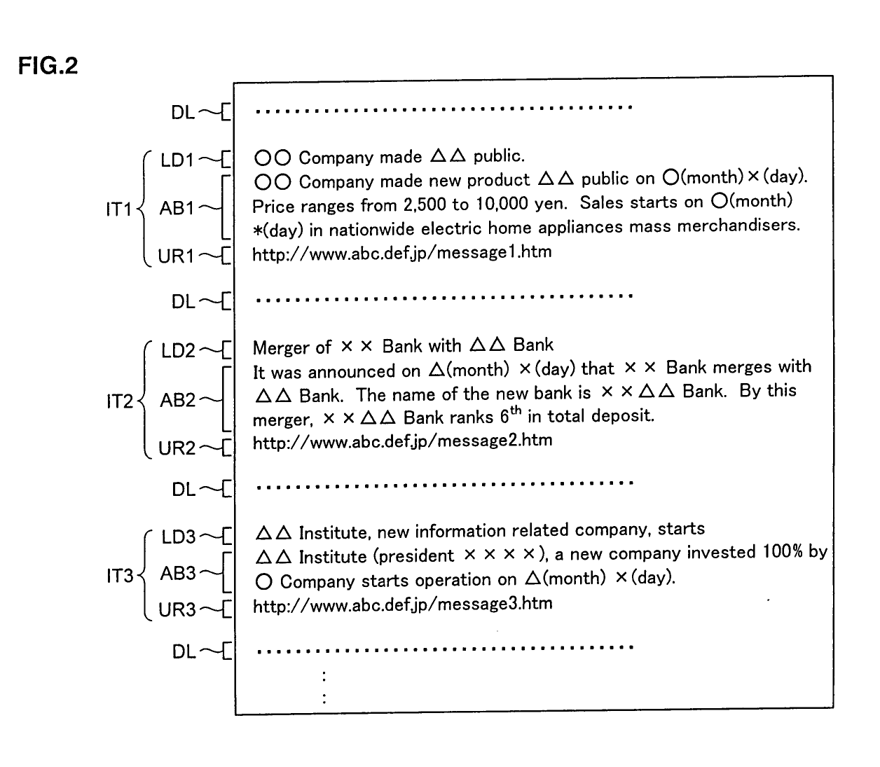

By way of example, the body of the mail magazine ME1 is described as shown in FIG. 2 if the mail magazine ME1 is a news mail magazine.

Namely, multiple articles (e.g., IT1 to IT3) reporting different cases are divided at predetermined divisions (separators) DL's, respectively. The divisions vary from a row consisting only of em dots such as . . . as shown in FIG. 2 to a blank row, and may differ according to mail magazines.

If patterns related to multiple types of divisions which can be used in mail magazines are stored in the division processing section 102, it is possible to extremely facilitate dividing an arbitrary mail magazine into respective articles (e.g., IT1 to IT3) by detecting sections consisting with one of the patterns.

Further, although the individual articles do differ in content, they are common to quite a typical structure if viewed from the user (e.g., U2) (i.e., conceptually). That is, leads (LD1 to LD3) are arranged first, the summaries of the cases (AB1 to AB3) are arranged second, and URL's (UR1 to UR3) which show the locations where the detailed articles of the cases (pieces of detailed information of the cases) are stored are arranged last.

If the user U2 wants to know the details of the articles, the user U2 accesses a Web page pointed out by each URL (e.g., UR2).

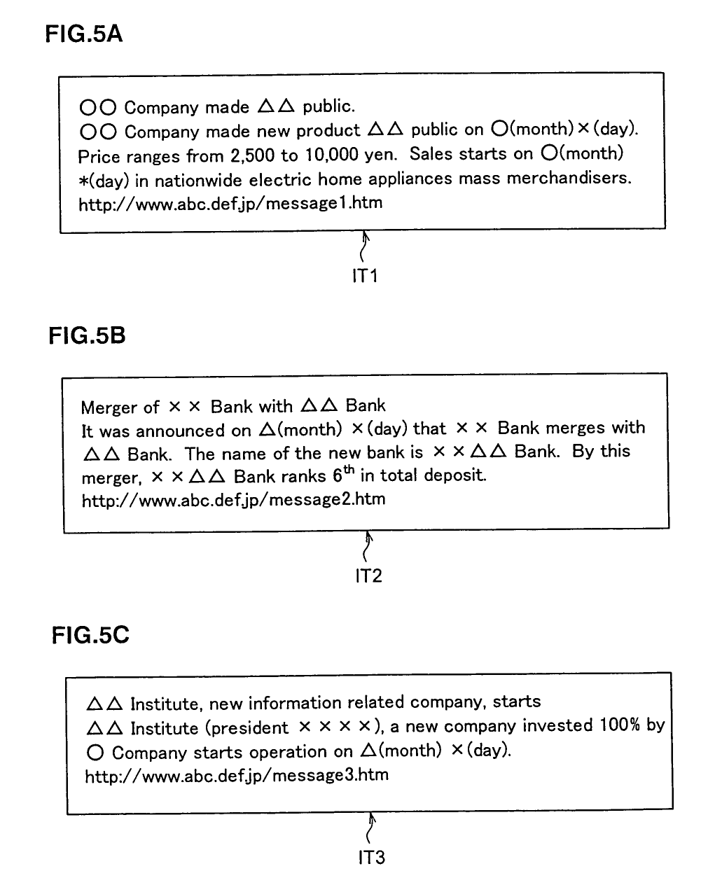

The respective articles IT1 to IT3 in the body shown in FIG. 2 are divided by the division processing section 1.02, as shown in FIGS. 5A to 5c.

The condition setting section 103 selects an article necessary to be notified to the user U2 from among the articles IT1 to IT3 in the mail magazine ME1 according to a select condition SP2 which is preset by the user U2 using the condition setting section 105. The select condition SP2 can be set as, for example, one or multiple keywords. By way of example, if “merger” is set as a keyword, only the article including the “merger” (IT2 in the example shown in FIG. 2) is selected. Needless to say, various keywords such as “information processing”, “broadband” and “network” other than “merger” can be set.

The notification section 104 notifies the user U2 of the content of the article which the condition setting section 103 determines to conform to the select condition SP2, in accordance with a notification condition SP3 set by the condition setting section 105. For example, the notification section 104 may transmit the content of the article to a preset notification destination at a preset notification timing.

For example, if a plurality of articles exist that conform to the select condition SP2, the notification section 104 may notify the user of the individual articles at different timings (over different e-mails) or may notify the user of the articles altogether over the same single e-mail. The notification timing can be set so as to transmit the notification (to the notification destination over e-mail) at, for example, eight o'clock in every morning. The number of notification timings that can be set is not necessarily limited to one.

It is considered that all the contents (LD2, AB2 and UR2 in this embodiment) of the selected article (e.g., IT2) are not necessarily notified to the user U2 by this notification. As in the example of FIG. 2, if it is known in advance that all the contents of one article do not include so many characters, it is easy to notify the user of all the contents by this notification. In this embodiment, therefore, it is assumed that the notification section 104 notifies the user of all the contents.

Various communication means can be used for the notification. For example, if the user U2 carries a cellular phone having a mailer installed therein, it is possible to use the e-mail of the cellular phone over which it is instantly possible to notify the user U2 of the arrival of an e-mail by means of a ring tone or a vibration wherever the user U2 is.

In the e-mail system of a cellular phone, the upper limit of the number of characters that can be described in an e-mail is set considerably low by cellular phone companies (e.g., some cellular phone companies set the number of characters to a maximum of 250). However, with such a small number of characters as shown in FIG. 2, it is possible to convey the entire sentences to the user U2 whichever cellular phone network operated by which cellular phone company the cellular phone of the user US belongs to.

Further, if the mailer or the like of the communication terminal 21 permits viewing the content of the subject (“Subject field”) of an unopened e-mail, the e-mail (the article IT2 described in the body of the e-mail) having the Subject field in which “arrival of an merger article” or the like is described is received in the mail box for AD2. By doing so, it is also possible to notify the user of the arrival of the desired article and lessen the operation burden of the user U2 while saving labor for opening individual e-mails in the mail box.

If the communication terminal 21 has a dedicated software installed therein, a window for notification is forced to be opened through a Web browser, a wallpaper, a screen saver or the like using a push type technique, so that it is possible to display the arrival of the merger article and the contents of the article (e.g., the contents of the article IT2) in this notification window. At this time, since the notification window is automatically (forcedly) opened, there is no need for the user U2 to perform any operations differently from reading an e-mail. If the screen saver is used through which the notification window is opened, the notification window is displayed many times and there is little probability that the user U2 misses the notification.

Furthermore, if the FAX number of a desired FAX terminal is preset, the system can be easily extended to receive e-mails over FAX.

Before or after the notification of the e-mail by the notification section 104, the mail processor 15 may automatically delete the entire sentences of the mail magazine ME1 in the AD2 mail box or the articles unselected by the condition determination section 103 among the divided articles of the mail magazine ME2. By doing so, it is possible to save the limited storage capacity of the mail box and to ensure receiving new e-mails (including mail magazines other than ME1).

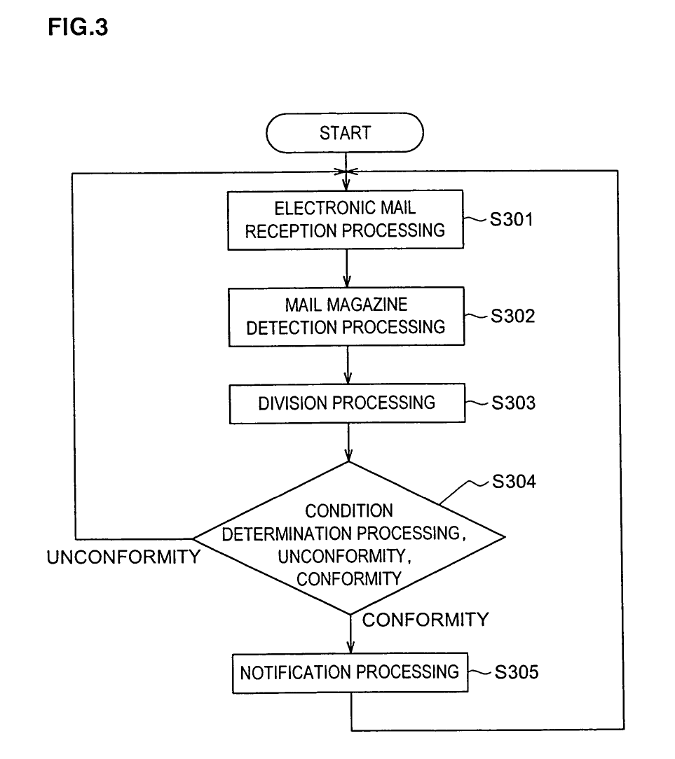

The operation of the first embodiment constituted as stated above will next be described with reference to the flow chart of FIG. 3.

The flow chart of FIG. 3 consists of steps S301 to S305.

(A-2) Operation of the First Embodiment

Before receiving the mail magazine ME1, the user U2 sets the detection condition SP1, the select condition SP2, and the notification condition SP3 for the mail magazine detection section 101, the condition determination section 103, and the notification section 104, respectively, by means of the condition setting section 105.

The select condition SP2 for the condition determination section 103 can be set in the form of a keyword or keywords as stated above or a question sentence. For example, the select condition SP2 can be set in the form of such a question sentence as “what is the new product of a notebook personal computer of ◯◯ company?” or “what is this week's school course?”.

Further, it is unnecessary to limit the number of condition items to be set for any of the detection condition SP1, the select condition SP2, and the notification condition SP3 to one but multiple condition items can be set simultaneously.

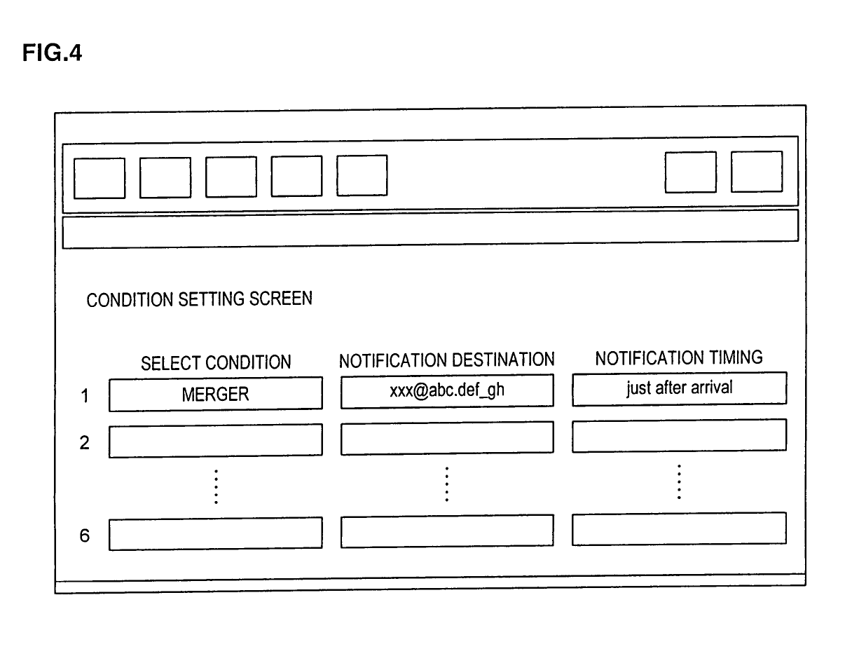

For example, if the select condition SP2 and the notification condition SP3 among these conditions are to be set, a GUI screen which the user U2 views through the Web browser of the communication terminal 21 may be that shown in FIG. 4.

In the example of FIG. 4, keyword “merger” is described as the first condition item of the select condition SP2 is, and the e-mail address of the notification destination XXX@abc.def.gh and the notification timing “just after arrival” are described as the first condition items of the notification condition SP3.

Second to sixth condition items can be similarly set.

If any one of the multiple select condition items (e.g., six select condition items) that are simultaneously set is satisfied, the user is notified.

In the example of FIG. 4, the e-mail reception section 100 receives the e-mail (e.g., ME1) (in the step S301 of FIG. 3), the mail magazine detection section 101 performs a processing to determine whether the e-mail ME1 conforms to the detection condition SP1 of the mail magazine detection section 101 (in the step S302 of FIG. 3), then the division processing section 102 divides the contents of the body of the e-mail ME1 according to the articles based on the divisions (e.g., “ . . . ”) (in the step S303 of FIG. 3), and the condition determination section 103 determines whether or not an article (including keyword “merger”) that conforms to the select condition SP2 exists (in the step S304 of FIG. 3).

If there is no article that conforms to the select condition SP2, the step S304 is branched toward a nonconformity side and the processing returns to the step S301. If at least one article that conforms to the select condition SP2 exists, the step S304 is branched toward a conformity side and the processing goes to the step S305.

If it is assumed that only the article IT2 shown in FIG. 2 conforms to the select condition SP2, the notification section 104 instantly transmits an e-mail having the article IT2 included in the body thereof to the e-mail address XXX@abc.def.gh (in the step S305) and the processing returns to the step S301.

The reason for transmitting the e-mail to XXX@abc.def.gh is that XXX@abc.def.gh is described as the notification destination on the screen shown in FIG. 4 and the reason for instantly transmitting the e-mail is that “just after arrival” is described as the notification timing on the screen shown in FIG. 4.

If XXX@abc.def.gh is, for example, the e-mail address of the cellular phone of the user U2, the arrival of this e-mail in a mail box for the cellular phone (which mail box is different from the AD2 mail box and provided in a cellular phone network, not shown) is instantly conveyed to the user U2 by a ring tone or a vibration produced by the cellular phone and the user U2 can, therefore, read the contents of the e-mail (the content of the article 12 and the like) using the user's cellular phone.

If the select condition SP2 is set in the form of a question sentence, the question sentence is converted into one or a plurality of keywords in the condition setting section 103. It is thereby possible to replace the processing for the select condition SP2 by the same processing for a case where the select condition SP2 is set in the form of a keyword or keywords by the user U2.

For example, if the question sentence of the above-described “what is the new product of a notebook personal computer of ◯◯ company?” is set as the select condition SP2, then the respective articles are searched first with “◯◯ company” set as a keyword, the meaning of the article including the keyword “◯◯ company” obtained as a result of the search is analyzed, it is determined whether or not an article having a description corresponding to the product name of the notebook personal computer exists, and the article having the description corresponding to the product name is dealt with as the article that conforms to the select condition SP2.

At need, a database which stores the concrete name of the new product of the notebook personal computer of ◯◯ company may be formed, an environment that makes such a database accessible, it may be determined whether or not an article conforms to the select condition SP2 based on whether the article includes a description corresponding to the concrete product name. The name of the new product and the like can be acquired relatively easily by the access to the Web site of the ◯◯ company or the like from the condition determination section 103.

If the select condition SP2 is set in the form of a question sentence, the corresponding article may be contained in the e-mail or the like and notified to the user U2 similarly to a case where the select condition SP2 is set in the form of a keyword or keywords. Alternatively, only an answer sentence to the question sentence may be notified to the user U2. Generally, the number of notified characters is smaller if only the answer sentence rather than the article itself is notified to the user U2.

The answer sentence is, for example, “the name of the new product of the notebook personal computer of ◯◯ company is ◯Δ”.

(A-3) Advantage of the First Embodiment

According to the first embodiment, it is determined whether each of the divided articles conforms to the select condition (SP2) and only the article that conforms thereto (or the answer sentence created from the article) is notified to the user (e.g., U2). Therefore, differently from the conventional art, the user is not notified of a summary of irrelevance to the keyword (i.e., a summary that does not conform to the select condition SP2), thus making it possible to improve the reliability of the system.

As a result, the user (U2) can receive an expected notification and does not feel uncertain about the normality of the system, thus making it possible to maintain the reliability of the system high.

Furthermore, in this embodiment, the URL (e.g., UR2) which shows the location where the detailed article of the case is stored is arranged in the notified article. However, the user (U2) does not need to access the Web page pointed out by the URL except that the user wants to know the detail of the article but may only receive the notification. Therefore, it is possible to save operations for accessing the Web page and the labor and time for reading the lengthy sentences of the Web page (detailed information), thus ensuring the high convenience of the system.

Moreover, if the user is notified only of the answer sentence, the user does not need to read all the entire sentences of even a shorter article (e.g., IT2) than the detailed information and can accurately know only the information that the user wants, thus further improving the convenience of the system.

Since the answer sentence includes a very small number of characters, it is possible to accurately display the information that the user wants even by a reception terminal such as the cellular phone, the display screen of which is small in size, thus ensuring the excellent convenience of the system.

(B) Second Embodiment

In the second embodiment, only the differences of the second embodiment from the first embodiment will be described.

The differences involve a difference in that if each divided article is insufficient in description (e.g., summary AB2) in light of the typical structure stated above, the description is compensated, a difference in that a logical structure (a hierarchical structure or a tree structure in this embodiment) corresponding to a conceptual structure is allocated to each divided article, a difference in that the article allocated the logical structure is stored and reused, and the others.

Further, in the first embodiment, the mail processor 15 provides only the push type information to the user U2 using the notification section 104 (provides information of such a type as to forcedly send back a response (information) if the preset condition is satisfied even without any request from the user). In the second embodiment, by contrast, a mail processor 25 can provide not only the same push type information as that in the first embodiment but also pull type information through a search section 204 (provides information of such a type as to send back a response only when the user requests).

(B-1) Configuration and Operation of the Second Embodiment

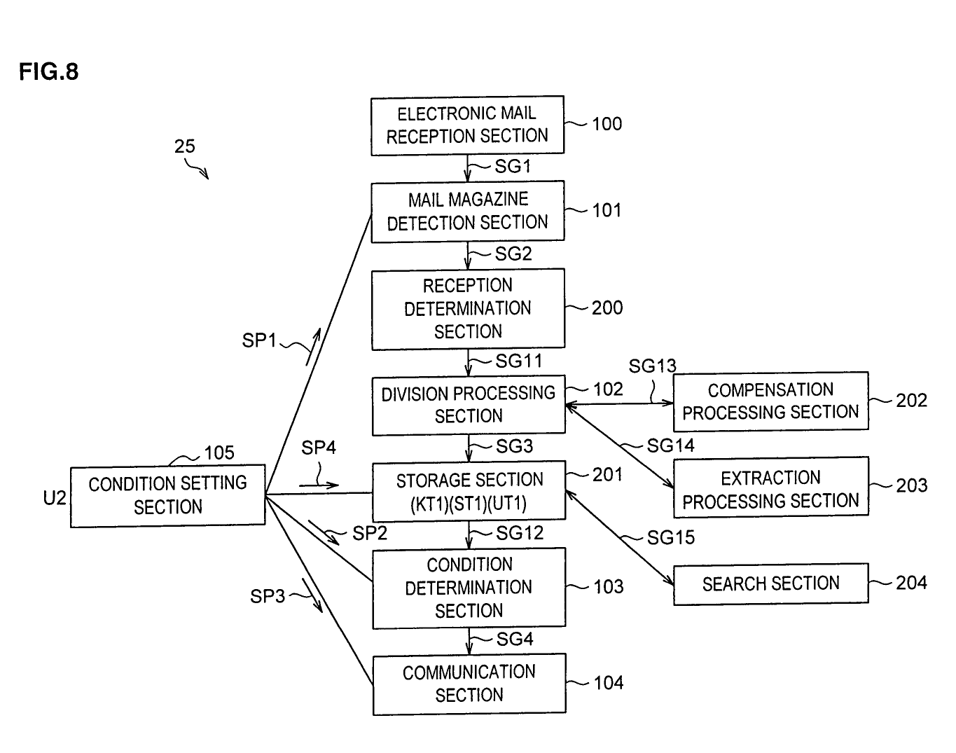

FIG. 8 shows an example of the configuration of the important sections of a mail processor 25 in the second embodiment. As shown in FIG. 16, this mail processor 25 is treated as the same as the mail processor 15 in the first embodiment in the overall communication system 10.

Referring to FIG. 8, the mail processor 25 includes an e-mail reception section 100, a mail magazine detection section 101, a division processing section 102, a condition determination section 103, a notification section 104, a reception determination section 200, a storage section 201, an compensation processing section 202, an extraction processing section 203, and a search section 204.

Among these constituent elements, those having the same or equivalent functions as those in the first embodiment are denoted by the same reference symbols 100, 101, 102, 103, 104, and 105 in FIG. 1, respectively, and will not be described herein in detail.

The reception determination section 200 arranged between the mail magazine detection section 101 and the division processing section 102 determines whether or not the mail magazine (e.g., ME1) determined to conform to the detection condition SP1 of the mail-magazine detection section 101 is already received and delivers only the mail magazine which is not received yet to the division processing section 102 provided in rear of the reception determination section 200.

In this embodiment, since the already received mail magazine is processed by the respective following sections 101, 202 and 203, stored in the storage section 201 and reused, it is unnecessary to process such a mail magazine repeatedly or two or more times.

Whether or not the mail magazine is already received may be determined while limiting a determination target to an individual user (an individual mail box). In this embodiment, however, determination is executed not for the individual user but all the mail boxes provided in the mail server 13. Therefore, if the mail magazine ME1 is already received in the AD2 mail box and processed by the mail processor 25, it is unnecessary to process the mail magazine ME1 in the mail processor 25 again even when the same mail magazine ME1 is received in the AD3 mail box.

If multiple users (one of whom is the user U2) the mail boxes for whom are provided in the same mail server 13, subscribe to the same mail magazine (e.g., ME1), the same mail magazine is received in the mail server 13 multiple times due to the function of the mailing list system stated above. It is possible to greatly save the processing capability of the mail processor 25 by using the reception determination section 200.

The mail magazine is normally issued only once but regularly or at appropriate time. Therefore, in case of monthly issued mail magazine, for example, it is necessary to discriminate a mail magazine of May 2002 issue from a mail magazine of June 2002 issue, for example. If the mail magazines are not thus discriminated, the reception determination section 200 omits a processing for the June 2002 issue for the reason that the mail magazine of May 20002 issue has been already received.

This discrimination can be made based on, for example, the content of the description of the Subject field included in the mail header of each mail magazine if the description of the Subject field reflects the difference between the May 2002 issue and the June 2002 issue.

In the first embodiment, only the article that conforms to the select condition SP2 preset by the user U2 is divided from the mail magazine and notified to the user U2. However, even if an article that does not conform to the select condition SP2 set by a certain user (e.g., U2), the article may possibly conform to the select condition SP2 that the other user is to set or may possibly be searched by the search section 204 to be described later. Such an article is not always information of no value. Considering this, in this embodiment, all the articles in the mail magazine (e.g., ME1) are preferably processed and stored in the storage section 201 whether or not the articles conform to the select condition SP2.

It is noted, however, that in the second embodiment similarly to the first embodiment, the notification section 104 notifies each user (e.g., U2) only of the article that conforms to the select condition SP2 preset by the user U2.

The compensation processing section 202 connected to the division processing section 102 checks whether or not there is an insufficient description (e.g., LD1 as a lead, AB1 as a summary, and UR1 as an URL) in the articles divided by the division processing section 102 in light of the typical structure shown in FIG. 2. If there is such insufficient description, the compensation processing section 202 compensates for the insufficient description and completes the typical structure.

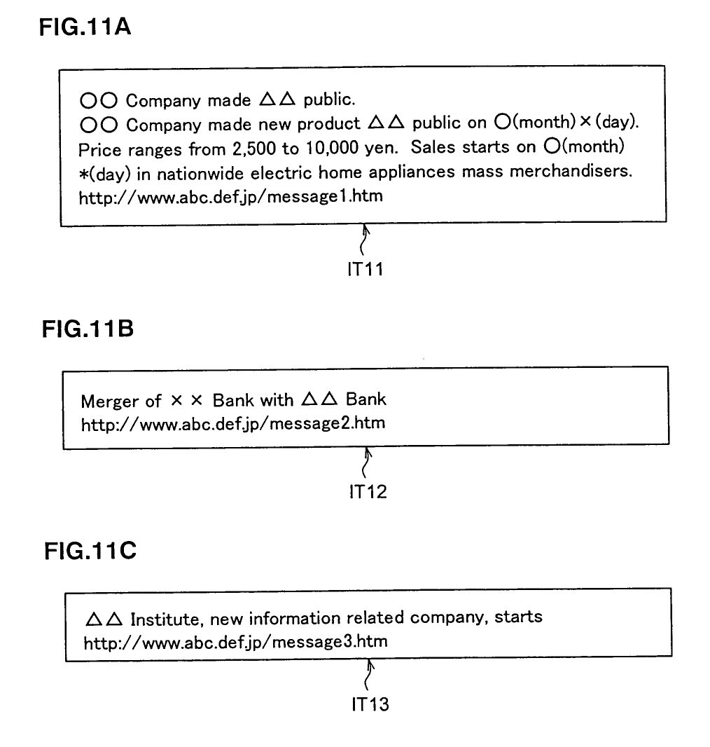

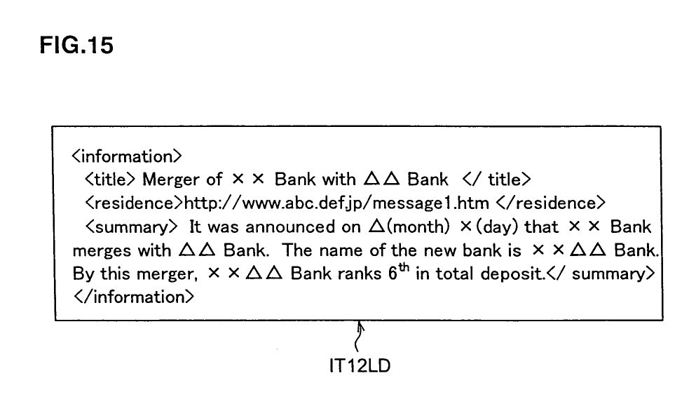

For example, articles IT12 and IT12L shown in FIGS. 11B and 13, respectively, are lacking in summaries which should be included in light of the typical structure show in FIG. 2. In this case, the compensation processing section 202 compensates for the content of the summary in each article IT12 or IT12L and changes, the article IT12L to, for example, an article IT12LD shown in FIG. 15.

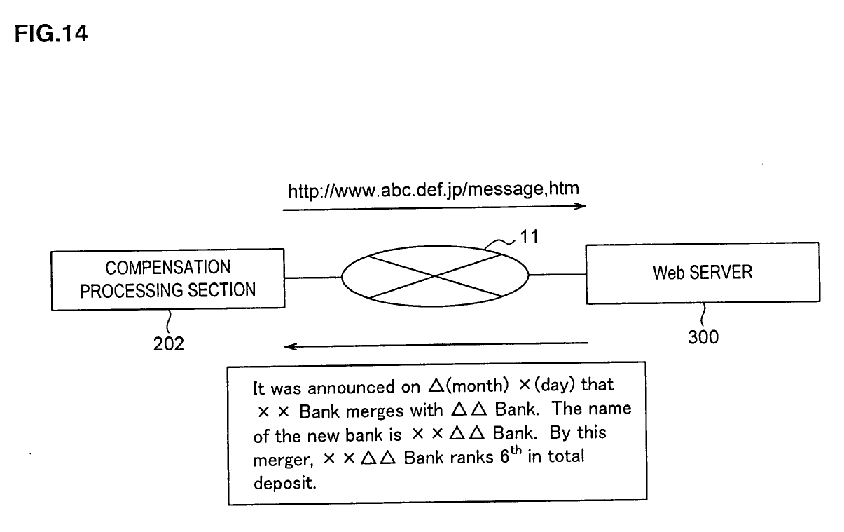

To execute this compensation, it is necessary to acquire a new description (the content of the summary in this embodiment) related to the article. The compensation processing section 202 accesses a Web server 300 which provides detailed information on (a Web page of) the article using the URL (e.g., UR1) as shown in FIG. 14, making it possible to acquire the description.

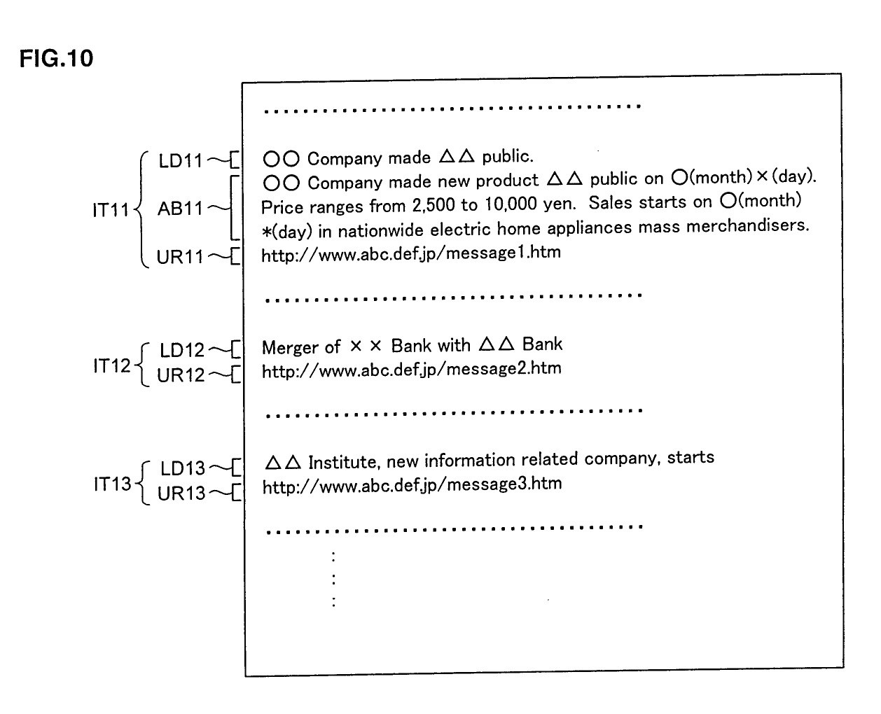

It is assumed herein that the content of the body of the mail magazine is, for example, that shown in FIG. 10. An article IT11 includes all of a lead (LD11), a summary (AB11) and URL (UR11) and has the typical structure whereas an article IT13 similarly to the article IT12 is lacking in a summary and in an insufficient state in light of the typical structure. Therefore, it is necessary to compensate for the article IT13 by the compensation processing section 202.

FIGS. 11A to 11C show the respective articles IT11 to IT13 obtained after the division processing section 102 divides the body of the mail magazine. In this case, the compensation processing section 202 compensates for the summary of the article IT3 shown in FIG. 11C as well as that of the article IT 12 shown in FIG. 11B.

The compensation processing section 202 may the description acquired by accessing the Web server 300 as the summary of the article (e.g., IT2) as it is. If the description includes too many characters and is inappropriate for the summary, the compensation processing section 202 may conduct a natural language processing to summarize the description acquired from, for example, the Web server 300 and use the resultant description as the summary.

If the article is lacking in not the summary but the lead, the lead can be compensated in exactly the same manner. However, if the article is lacking in the URL, the URL cannot be compensated in the same manner.

Nevertheless, if a search engine service or the like provided on the Internet is used, it is not always impossible to narrow down and specify the URL by doing a search with a sufficient number of keywords.

If the URL cannot be compensated or is not compensated, the following processing is performed while the URL remains uncompensated.

The extraction processing section 203 connected to the division processing section 102 similarly to the compensation processing section 202 allocates a logical structure to each of the divided articles obtained by the division processing section 102 and marks up the meaning of each description in each article. The allocation of the logical structures, i.e., markup can be made by using, for example, XML. Using the XML, tags and attributes can be freely defined.

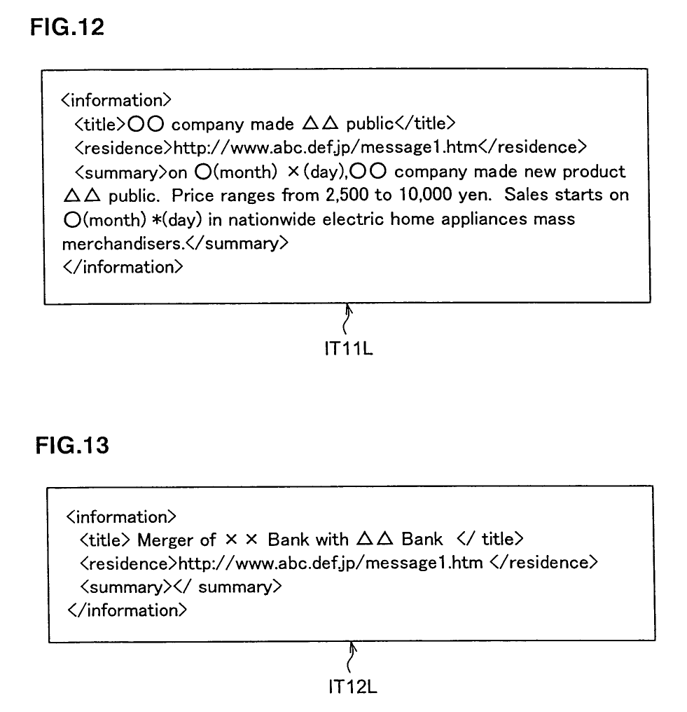

If the extraction processing section 203 allocates the logical structures to the respective divided articles, for example, the article IT11 shown in FIG. 11A changes to an article IT11L shown in FIG. 12 and the article IT12 shown in FIG. 11B changes to an article IT12L shown in FIG. 13, for example.

The article IT11L, for example, has a nesting structure in which pairs of tags of a title, a residence and a summary that are lower elements are inserted between a pair of information tags (i.e., a start tag <information> and an end tag </information>) showing the highest element (an element on the outermost side).

In other words, this article has a tree structure in which the information as the highest element is a parent and the title, the residence and the summary as the lower elements are three children relative to this one parent.

With this structure, if the respective descriptions of the article (e.g., IT11) are marked up, it means that the article is allocated a logical structure (a tree structure in this embodiment).

It is noted that “information” in the information tags corresponds to “article” in the first embodiment, “title” in the title tags corresponds to “lead” in the first embodiment, “residence” in the residence tags corresponds to “URL” in the first embodiment, and “summary” in the summary tags corresponds to “summary” in the first embodiment.

In FIG. 12, elements which become children of the title tags, the residence tags and the summary tags as the lower elements can be further generated (marked up).

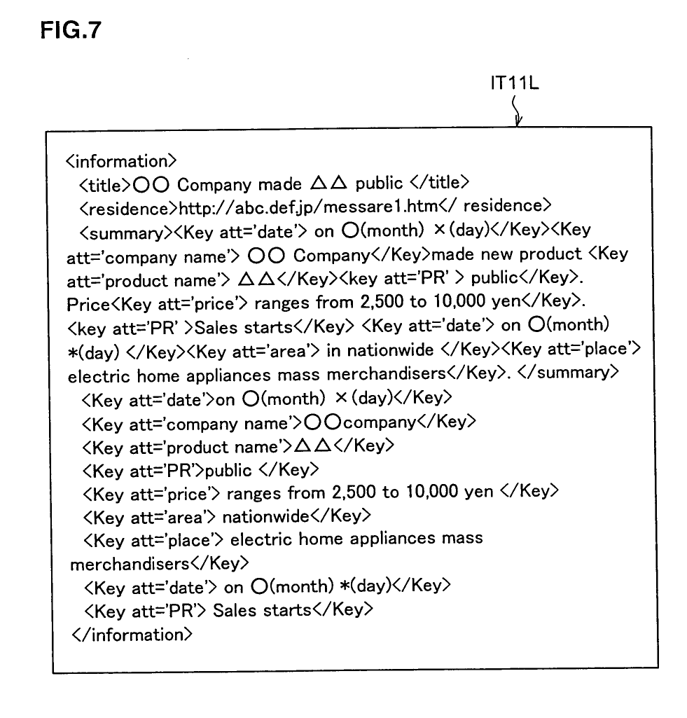

For example, if each description in the summary is marked up, the article IT11L changes to an article IT11LA shown in FIG. 7 as one example.

In FIG. 7, for example, “key att=‘date’>◯(month)×(day)</key?> is a markup obtained by putting “on ◯(month)×(day)” indicating date between date key tags <key att=‘date’> and </key>. Likewise, such descriptions in the summary as “◯◯ Company” indicating company name, “ΔΔ” indicating product name, “public” indicating PR (propaganda), “2,500 to 10,000 yen” indicating price are marked up by characteristic tags, respectively.

The descriptions marked up herein may serve as keywords in order of search.

By thus marking up the descriptions, it is possible to clearly determine that, for example, “2,500 to 10,000 yen” indicates price based only on the tags. In the later processings, it is possible to omit a complicated natural language processing so as to analyze that “2,500 to 10,000 yen” is a price. This also applies to the descriptions other than “2,500 to 10,000 yen” in the summary.

As is obvious from FIG. 7, words such as postpositional words that cannot become search keywords are not marked up.

The article IT11LA which is allocated the logical structure and is in the form shown in FIG. 7 is processed by an appropriate user interface (e.g., a browser for the XML installed on the communication terminal 21), whereby the article can be displayed in a normal state as shown in FIG. 5A.

If necessary, if the notification section 104 notifies the user of the article, the article may be transmitted by returning to a form in which the logical structure is eliminated from the article. That is, the article IT11LA shown in FIG. 7 is transmitted by converting the article IT11LA into the article IT1 shown in FIG. 5A. If the logical structure is allocated to the article, the quantity of data on the article (the data size of the article) increases. By converting the article IT11LA into the article IT1 and transmitting the article IT1, it is possible to decrease the transmitted data quantity.

The storage section 201 connected to the division processing section 102 is a database which stores and manages the articles (pieces of information) processed by the compensation processing section 202 and the extraction processing section 203 in units of articles. The stored contents of the storage section 201 are searched by the condition determined section 103 and the search section 204 (or reception determination section 200). In this embodiment, the storage section 201 is constituted as a relation database and managed by RDBMS.

The search section 204 executes a search to each article stored in the storage section 201 in response to an input of a search keyword or search keywords or a question sentence from the user U2, and returns an answer sentence to the search result or the question sentence.

If the search section 204 has a function as a Web server, the user U2 can supply a request in the form of such a search or a question sentence to the search section 204 using the Web browser installed on the communication terminal 21 and also receive the search result or answer sentence as a response to the search or question sentence.

At need, means other than such a hypertext system may be used as a communication means between the search section 204 and the communication section 21.

For example, an e-mail system can be used.

For example, if a command such as “user=User2, keyword=merger” is described in the body of the e-mail in accordance with a preset configuration and the e-mail is transmitted, the search request can be transmitted to the search section 204. Needless to say, the other configuration such as CSV form can be used.

In this command, “User2” is the name of the mail box and is information which the user U2 can easily know from the e-mail address AD2 of the user U2. It is obvious that “User2” can be modified to the e-mail address AD2 of the user U2 as well as the domain name. In addition, if the name of the user U2 or the like can be described in place of “User2”, it becomes a user interface convenient to an unfamiliar user. In this case, however, the search section 204 newly needs to manage the correspondence between user identification information to be described later and the user name.

If the search request is transmitted over e-mail, generally, it is natural and convenient to receive the search result over e-mail.

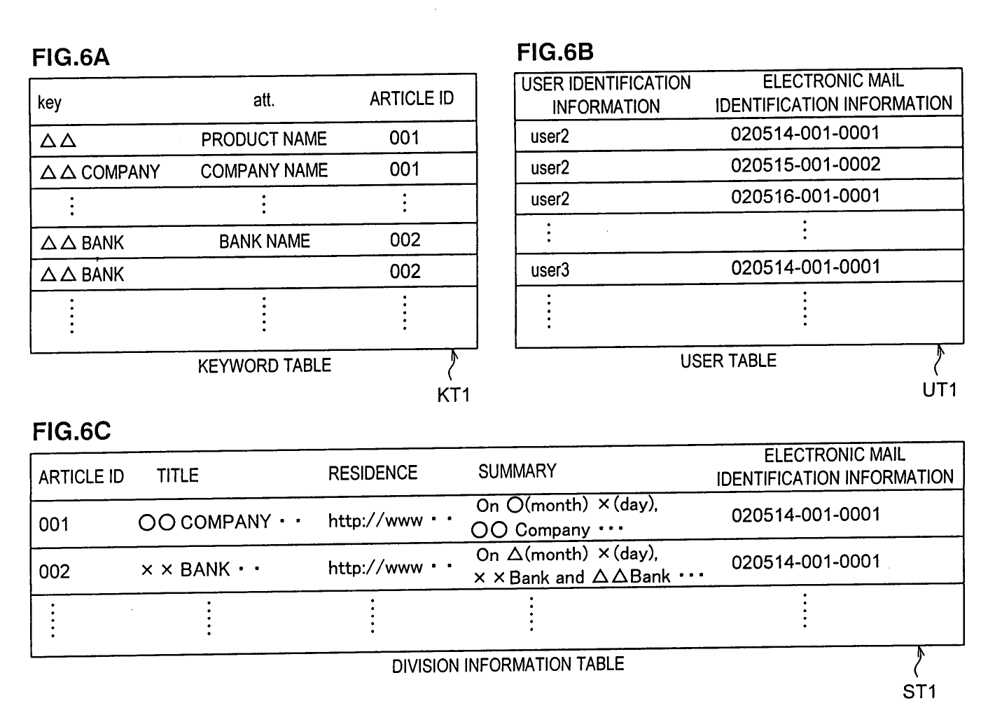

The storage section 201 includes a keyword table KT1 shown in FIG. 6A and a user table UT1 shown in FIG. 6B as well as a division information table ST1 shown in FIG. 6C so that contents of the storage section 201 are searched by the search section 204, the condition determination section 103 and the reception determination section 200.

The division information table ST1 is a table for managing the articles processed by the compensation processing section 202 and the extraction processing section 203 in the units of articles. In the example of FIG. 6A, an article ID for identifying each article, a title showing the lead of each article, a residence showing the URL of detailed information on each article, a summary showing the summary of each article, and an e-mail identification information for containing each article in the body of the e-mail and identifying the original e-mail (e.g., ME1) arriving at the mail server 13 are provided as column names of the table ST1.

The e-mail identification information is stored in the division information table ST1 so as not to process and store again the e-mail (mail magazine) already stored in the division information table ST1. If such an overlapping processing or storage occurs, the processing ability and storage resources of the mail processor 25 are wastefully consumed.

It is, therefore, preferable that this e-mail identification information can be referred to whenever the reception determination section 200 needs it. Alternatively, the e-mail identification information may be generated by the reception determination section 200 or the like based on the content described in the Subject field.

The user table UT1 shows the correspondence between each of the users (including U2) who have mail boxes in the same mail server 13 and who are subscribers to the mail magazine and the e-mail identification information. The keyword table KT1 shows the correspondence among the keyword (key), the attribute (att) and the article (ID).

Many articles divided from many mail magazines are stored in the division information table ST1. Since it is necessary for each user to be able to refer to only the articles of the mail magazine to which the user subscribes, the user table UT1 is necessary.

Namely, it is necessary to prevent the user U2 from knowing the articles divided from the mail magazine to which each user (e.g., U2) does not subscribe and shown in the division information table ST1, by using the user table UT1.

If the mail magazine is free of charge and does not require giving a restriction so that only subscribes who are registered with the mail magazine in advance can read the mail magazine, and if the user wants to read such a mail magazine, the restriction may not be given.

If such a restriction is eliminated in case of providing the push type information, the user is flooded with unnecessary articles from the notification section 104, which becomes an unfavorable result for the user U2. Conversely, in case of providing the pull type information using the search section 204, it is considered to be preferable to the user U2 to eliminate the restriction. This is because the user U2 can view the contents of the mail magazine to which the user U2 does not subscribe to if the user so desires.

However, if the restriction is necessary for the purpose of copyright protection, the restriction may be given even in case of providing the pull type information.

The keyword table KT1 is used to extract only the keywords and attributes of articles stored in the division information table ST1 and put them in order in advance, and to show the correspondence among a keyword, an attribute and an article ID. This table KT1 can be mainly used for the acceleration of the search.

For example, if the select condition SP2 is transmitted to the condition determination section 103 from the user U2 as a keyword, the condition determination section 103 searches the keyword table KT1 with the keyword transmitted used as a search key and obtains an attribute and an article ID as a result of the search (the condition determination section 103 may possibly obtain multiple pairs of attributes and article ID's). Next, using the article ID thus obtained as a search key, the condition determination section 103 searches the division information table ST1 and obtains a summary as a result of the search. Further, using this summary as well as the attribute and the keyword as search keys, the condition determination section 103 does a search and confirms that the summary is what the user U2 wants. If the condition determination section 103 confirms so, the condition determination section 103 acquires the title and the residence in the row corresponding to the summary in the division information table ST1, reconstructs the article with the typical structure using the obtained title, summary and residence, and provides the reconstructed article to the user U2.

If the user identification information on the user U2 is acquired in advance, the user table UT1 is searched with the user identification information on the user U2 used as a search key so as to set only the mail magazine to which the user U2 subscribes as a search target in searching the division information table ST1, then it is possible to easily realize setting only the row which includes the e-mail identification information (e.g., “020514-001-0001” and “020515-001-0002”) obtained by the search for the user table UT1, as a target in searching the division information table ST1 among a series of processings described above.

If the select condition SP2 set is transmitted from the user U2 to the condition determination section 103 in the form of a question sentence, the question sentence is analyzed to thereby obtain a keyword or keywords as described in the first embodiment. By doing so, the later processings for searching the tables KT1, UT1 and ST1 can be performed in the same manner as that if the select condition SP2 is transmitted to the condition determination section 103 as a keyword.

The keywords and attributes (such as “◯◯ Company” and “Company Name”) registered in the keyword table KT1 are acquired from the summaries of the respective articles. A processing for extracting only the keywords and attributes from the summaries of the articles and the like can be executed extremely easily by, for example, allocating the logical structures to the respective articles' as shown in FIG. 7.

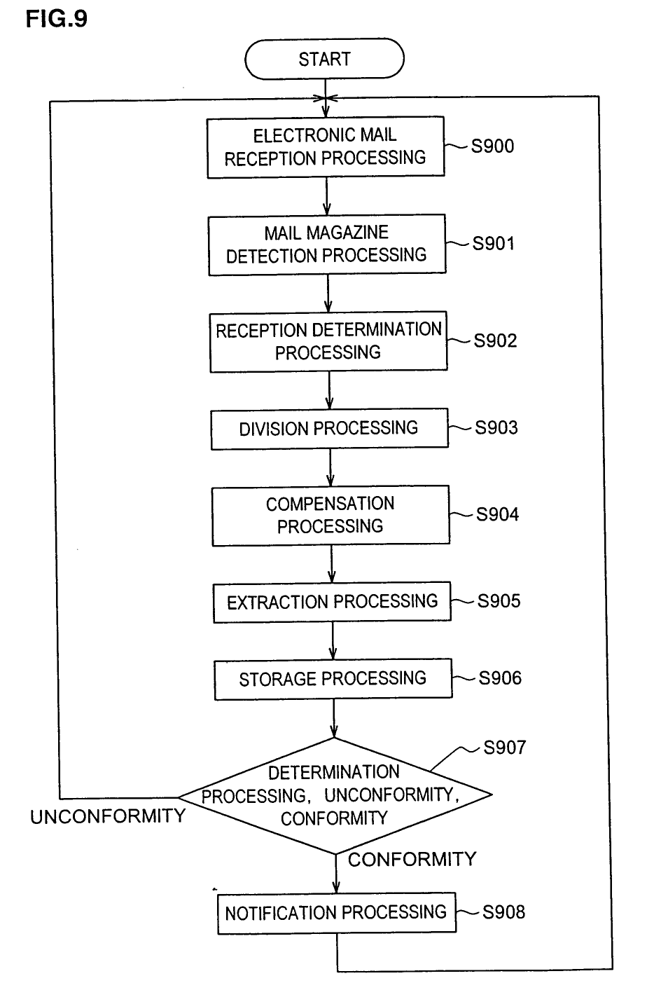

The operation of the mail processor 25 in this embodiment has a processing flow shown in, for example, the flow chart of FIG. 9. The flow chart of FIG. 9 consists of steps S900 to S908. It is noted that many of them shown in FIG. 9 indicate the same processings as those shown in FIG. 3.

Namely, the step S900 corresponds to the step S301, the step S901 corresponds to the step S302, the step S903 corresponds to the step S303, the step S907 corresponds to the step S304, and the step S908 corresponds to the step S305.

Further, a reception determination processing in the step S902 indicates a processing corresponding to the reception determination section 200, a compensation processing in the step S904 indicates a processing corresponding to the compensation processing section 202, an extraction processing in the step S905 indicates a processing corresponding to the extraction processing section 203, and a storage processing in the step S906 indicates a processing performed by the storage section 201 to store the respective articles and the like processed by the division processing section 102 the compensation processing section 202 and the extraction processing section 203.

Obviously, therefore, after the storage processing (S906) is performed, the user U2 can always access the search section 204 and receive the above-stated pull type information although FIG. 9 only shows processings related to the provision of the push type information.

(B-2) Advantage of the Second Embodiment

The second embodiment can attain the equivalent advantages as those of the first embodiment.

Further, in the second embodiment, even if the structure of the article in the mail magazine is against the typical structure, the user (U2) can receive the article having the typical structure by the compensation processing. Due to this, the necessity for the user oneself to access the Web server (300) which provides the detailed information (Web page) so as to compensate for the insufficient part lowers, making it possible to decrease communication frequency and to ensure high efficiency and convenience.

In addition, even if the location of the summary is indicated by the URL or the like and the communication terminal (21) does not has a Web browser installed thereon, the highly flexible system which can be used by allowing the notification section (104) to notify the user over e-mail and the condition setting section (105) or the like to be constituted to include a mailer.

Furthermore, the locations where detailed information on (Web pages of) the individual divided articles are normally distributed in a wide range. In this embodiment, by also acquiring the detailed information and storing the detailed information in the storage section (201), it is possible to intensively manage the detailed information. It is thereby possible for the mail processor (25) to carry out the management of the throughput of the Web access from the user (U2) and the like.

In this embodiment, the logical structures are allocated to the respective articles and the articles are then stored in the storage section (201). It is, therefore, possible to improve the efficiencies of various processings to be conducted to the articles after the storage of the articles.

For example, it is possible to efficiently perform a processing for extracting keywords from the articles. Therefore, if sufficient keywords cannot be extracted only from the leads of the articles (titles), it is also possible to extract accurate keywords from the summaries of the articles. As a result, matching accuracy improves and high search performance can be expected.

(C) Other Embodiment

If a field, in which a magazine ID which is identification information on the mail magazine is described, is provided as a field that the publisher U1 can freely add in the mail header, the mail magazine detection section 101 can identify the mail magazine ME1 using the information described in the added field in both the first and second embodiments.

Further, processing efficiency may be sometimes improved by reversing the processing order for the division processing section 102 and the condition determination section 103 in the first embodiment (or both the first and second embodiments if all the articles are not stored in the storage section 201). The reason is as follows. If the article that conforms to the select condition SP2 does not exist (the keyword is not included in any articles), it is not at all necessary to divide the mail magazine. If only part of the articles include the keyword, it suffices to divide the mail magazine only at the divisions before and after the articles (while omitting dividing the mail magazine at the other divisions).

Furthermore, in the first and second embodiments, the e-mail (e.g., ME1) broadcast from the mail server 14 is directly received by the mail server 13. Needless to say, a mail transfer service may be provided between the mail servers 14 and 13. The same thing is true for the mail servers 12 and 14.

In the first and second embodiments, the news mail magazine has been described as an example of the e-mail the body of which includes a plurality of contents. Mail magazines other than the news mail magazine and e-mails other than the mail magazine may possibly include a plurality of different contents in the respective bodies. The present invention is also applicable to those e-mails. For example, an e-mail the body of which includes a plurality of recipes may be divided according to the recipes.

The application of the present invention is not always limited to e-mail. The present invention is also applicable to, for example, WebZin which is an online magazine using WWW.

If a plurality of articles that conform to the select condition SP2 exist, it is preferable to categorize the articles and transmit them for each category or to divide the articles put in order according to a certain transmission size and transmit the divided articles.

In the second embodiment, processing efficiency is sometimes improved by reversing the processing order for the compensation processing (S903) and the extraction processing (S904).

The reason is as follows. In the course of the compensation processing, it is necessary to determine which the respective descriptions in each article correspond in light of the typical structure (see FIG. 2) and to make the same determination in the extraction processing. By performing the extraction processing, allocating the logical structures to the respective articles and then performing the compensation processing, it is possible to make this determination extremely easily in detail based on the description of the tags and attributes in the compensation processing.

Needless to say, in this case, if the description (e.g., summary) is compensated for, it is necessary to execute the extraction processing and to allocate the logical structure to the article for the compensated description.

In the tables KT1, UT1 and ST1 shown in FIGS. 6A, 6B and 6C and used in the second embodiment, the column names may be omitted or column names other than those shown may be added. The tables may be standardized at need. While the tables KT1, UT1 and ST1 shown in FIG. 6 can be treated as actual tables, it is also possible to treat them as view tables.

Furthermore, in the storage section 201 in the second embodiment, DBMS other than RDBMS may be certainly used at need.

In the first and second embodiments, some concrete examples are shown in relation to the search methods for the searches done by the condition determination section 103, the search section 204 and the like. However, the application range of the present invention is not limited to these examples but the present invention is also applicable to other efficient keyword search methods and other methods for efficiently obtaining an answer to a question.

In the second embodiment according to the present invention, the e-mail (e.g., mail magazine) including a plurality of articles may be translated into a different language by machine translation and the converted e-mail may be stored in the storage section (201). For example, if the respective articles of the mail magazine are described in English, the articles are translated into Japanese prior to the extraction processing. By doing so, even if the keyword or keywords (including the question sentence) supplied from the condition setting section (105) are described in Japanese, the condition determination section 103 and the search section 204 can efficiently do searches.

Further, the article obtained as a result of a search is already translated into Japanese similarly to the keyword(s). Therefore, the user (U2) can know the contents of the article by providing the article to the user even thought the user is unfamiliar with English.

The compensation processing section 202 in the second embodiment compensates for (adds) the description (e.g., summary) in which the article is lacking in light of the typical structure. To modify the article to an article which conforms to the typical structure, processings other than the addition may be conducted at need.

For example, if an excess description exists in light of the typical structure, the description can be deleted or part of the descriptions in the article can be modified (which means a composite processing of deletion and addition) so as to conform to the typical structure.

In the first and second embodiments, the mail processor 15 or 25 is arranged on the mail server 13 side. Alternatively, the functions of the mail processor 15 or 25 can be arranged in the communication terminal 21. It is preferable to install them as a plug-in software as the extension of the function of an existing mailer since it can be realized more easily.

In both the first and second embodiments, division and search target data (e.g., the mail magazine in the first and second embodiments) is not necessarily received through the network.

For example, the data including a plurality of articles can be provided while storing the data in such a storage medium as a Floppy (registered trademark) disk or a CD-ROM as seen in the body of the above-stated mail magazine.

In both the first and second embodiments, the division processing section 102 may be omitted at need.

Additionally, regardless of the second embodiment, the compensation processing section 202, the extraction processing section 203 and the search section 204 can be omitted at need. Alternatively, only one of the search section 204 and the notification section 104 may be provided. If the notification section 104 is omitted, the condition determination section 103 can be certainly omitted.

While the present invention is mainly intended to be realized as a hardware in the above-stated description, the present invention can be also realized by a software.

As described so far, according to the information processing system and the information processing method of the present invention, it is possible to improve reliability and convenience and to maintain reliability high.

What is claimed is:

1. An information processing system for processing unit data including a plurality of information elements partitioned at predetermined divisions, the system comprising:
a division processing section dividing said unit data into the plurality of information elements based on the divisions;
a condition determination section supplied with a select condition, and selecting the information element conformable to the select condition from among the plurality of information elements obtained by dividing said unit data; and
a notification section notifying a user of the information element selected by the condition determination section.

2. The information processing system according to claim 1, comprising an extraction processing section allocating a logical structure to each of the information elements divided by said division processing section, the logical structure indicating a meaning of each information in each of the information elements.

3. The information processing system according to claim 2, wherein XML (extensible Markup Language) is utilized for allocation of said logical structure.

4. The information processing system according to claim 2, comprising a compensation processing section determining whether each of the information elements divided by said division processing section includes insufficient information in light of said logical structure, and compensating for the insufficient information to thereby complete a typical structure if there is the insufficient information.

5. The information processing system according to claim 4, wherein said compensation processing section compensates for said insufficient information by accessing a Web server providing detailed information on the information element including said insufficient information.

6. The information processing system according to claim 4, wherein if an excessive description exists in light of said logical structure, said compensation processing section delete the excessive description.

7. The information processing system according to claim 1, comprising a storage section storing one of said unit data and said information elements.

8. The information processing system according to claim 7, wherein said storage section stores identification information for identifying said unit data.

9. The information processing system according to claim 7, comprising a search section receiving an input of a search keyword or a question sentence, and thereby executing a search to articles stored in said storage section and returning an answer sentence in response to a search result or the question sentence.

10. The information processing system according to claim 1, comprising a translation section translating said information elements into a different language.

11. The information processing system according to claim 1, wherein said unit data is a mail magazine.

12. An information processing method for processing unit data including a plurality of information elements partitioned at predetermined divisions, comprising the steps of:
allowing a division processing section to divide said unit data into the plurality of information elements based on the divisions;
allowing a condition determination section to be supplied with a select condition, and to select the information element conformable to the select condition from among the plurality of information elements obtained by dividing said unit data; and
allowing a notification section to notify a user of the information element selected by the condition determination section.
